(19) United States
(12) Patent Application Publication
(10) Pub. No.: US 2010/0314857 A1
(43) Pub. Date: Dec. 16, 2010

(54) AIRBAG ARRANGEMENT

(75) Inventor: Ullrich Rick, Roxheim (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/518,021

(22) PCT Filed: Oct. 22, 2007
(86) PCT No.: PCT/EP07/61256

§ 371 Date: Jun. 5, 2009

(30) Foreign Application Priority Data
Dec. 6, 2006 (DE) 102006057503.2

(51) Int. Cl. B60R 21/205; B60R 21/215

(52) U.S. Cl. 280/728.2; 280/728.3

(57) ABSTRACT

An airbag arrangement for a motor vehicle includes, but is not limited to an airbag module which includes, but is not limited to an airbag and a gas generator for inflating the airbag. The airbag module is located inside a firing channel housing which allows target-oriented unfolding of the airbag. The firing channel housing is closed on the passenger side by a cover which is connected to the firing channel housing by means of a predetermined rupture line. The airbag and/or a flexible protective sleeve at least partially surrounding the airbag is connected to the firing channel housing in such a manner that the airbag or the protective sleeve contacts the firing channel housing. A fixed housing surrounding the airbag and the gas generator is thus saved, with the result that the weight of the airbag arrangement is reduced.

### CROSS-REFERENCE TO RELATED APPLICATIONS

This application is a U.S. National-Stage entry under 35 U.S.C. §371 based on International Application No. PCT/EP2007/061256, filed Oct. 22, 2007, which was published under PCT Article 21(2), and claims priority to German Application No. 102006057503.2, filed Dec. 6, 2006, which are all hereby incorporated in their entirety by reference.

### TECHNICAL FIELD

The invention relates to an airbag arrangement for a motor vehicle, in which an airbag is disposed in a motor vehicle component in such a manner that, for example, in the event of an accident, an airbag can inflate in order to protect the occupants of the motor vehicle from damage.

### BACKGROUND

In a conventional airbag arrangement, the airbag of an airbag module, which is inflatable with the aid of a gas generator, is disposed inside a housing, which is fastened to a transverse support of the motor vehicle bodywork. In the event of an accident, the airbag should pass through a dashboard of the motor vehicle as it inflates in order to protect a vehicle occupant. To this end, a predetermined rupture point is provided in the dashboard, which exposes a region through which the airbag can pass through as it inflates. In order that the airbag precisely hits this region, a firing channel housing is provided, which is connected to the dashboard and which is aligned onto the airbag module. During inflation of the airbag, the airbag initially breaks through the housing and is guided by the firing channel formed by the firing channel housing onto the region of the dashboard through which the airbag should pass.

It is known from DE 103 58 896 to dispose the airbag module inside the firing channel housing by connecting the housing of the airbag module to the firing channel.

A disadvantage with such an airbag arrangement is that passenger safety is provided at the expense of increasing the weight of the motor vehicle, with the result that, for example, the fuel consumption is increased.

It is at least one object of the invention to provide an airbag arrangement having a lower weight. In addition, other objects, desirable features, and characteristics will become apparent from the subsequent summary and detailed description, and the appended claims, taken in conjunction with the accompanying drawings and this background.

### SUMMARY

In the airbag arrangement according to an embodiment of the invention, an airbag is provided in a motor vehicle which comprises an airbag and a gas generator for inflating the airbag. The airbag module is at least partially located inside a firing channel housing, which is provided for target-oriented unfolding of the airbag. The firing channel housing is closed on the passenger side by a cover having a predetermined rupture line and is connected at least partially to the firing channel housing by means of this predetermined rupture line. Opposite to the cover, that is on the side of the firing channel housing facing away from the passenger, the firing channel housing is in particular open. According to an embodiment of the invention, the airbag and/or a flexible protective sleeve surrounding the airbag is connected to the firing channel housing, and the airbag or the protective sleeve contacts the firing channel housing in particular inside the firing channel housing. The airbag or the protective sleeve therefore abut directly against the firing channel housing. The airbag module therefore has no housing so that the weight of the housing is saved. Instead of fastening the airbag module with the aid of a housing to the motor vehicle, the fastening can be made directly via the airbag or the gas generator of the airbag or via an optionally provided protective sleeve. The protective sleeve can be provided to protect the airbag, which is a safety-relevant component, from contamination or damage, for example, during installation.

The tearing strength of the airbag connected in the firing channel housing and/or the tearing strength of the protective sleeve connected to the firing channel housing is preferably higher than the breaking strength of the predetermined rupture line. This ensures that during inflation of the airbag, the cover of the firing channel housing can be opened without the airbag being damaged. In particular, the high tearing strength of the airbag or the protective sleeve allows particularly stable fastening methods in order to connect the airbag or the protective sleeve to the firing channel housing. For example, the airbag or the protective sleeve can have an opening in order to screw the airbag or the protective sleeve to the firing channel housing with the aid of a screw connection. The opening is in particular reinforced, for example, metal-reinforced to facilitate screwing. In the event that a protective sleeve is provided, the protective sleeve preferably has a tearing strength that is lower than the tearing strength of the airbag, so that the airbag can optionally emerge from the protective sleeve through a predetermined rupture zone.

The airbag connected to the firing channel housing and/or the protective sleeve connected to the firing channel housing is particularly preferably connected to the firing channel housing in such a manner that the firing channel housing is completely closed towards the open end. In particular, the protective sleeve can form part of the closed firing channel whilst the other part is formed by the firing channel housing to which the gas generator is optionally connected in a fixed position. As a result, the protective sleeve is so to speak a part of the firing channel housing. In this case, the firing channel housing can, for example, merely be a plastic wall which can be manufactured simply by pressure die casting, to which the protective sleeve is connected in order to form a, for example, tubular firing channel due to its shaping. Particularly preferably, the protective sleeve has a predetermined rupture point so that the airbag can emerge from the protective sleeve and the protective sleeve can at the same time be manufactured from a material or composite material which can withstand the suddenly occurring pressure on inflation of the airbag, in order to in particular form a part of the firing channel.

It is thereby achieved that the airbag cannot propagate in a direction leading away from the passenger but can only propagate onto the cover of the firing channel housing. The entire force released on inflation of the airbag with the aid of the gas generator is thereby concentrated on the cover of the firing channel housing. This makes it possible to use a particularly small gas generator which additionally reduces the weight of the airbag arrangement.

The airbag and/or the protective sleeve is preferably detachably connected to the firing channel housing. For this purpose, a hook/eye connection, a clip connection, a Velcro fastener or a combination of various detachable connections can be provided. For example, the airbag or the protective sleeve can be suspended on one side of the firing channel housing by means of an eye in a hook and on another side, for example, opposite thereto, clipped or locked. This allows simple and secure mounting of the airbag module inside the firing channel housing.

The in particular substantially tubularly configured firing channel housing is preferably provided with ribs. A stable firing channel housing is achieved with a comparatively low material expenditure and therefore low weight.

The gas generator of the airbag module is particularly preferably connected to the firing channel housing. The gas generator is, for example, connected to the firing channel housing by a screw connection. The gas generator can, for example, be firmly connected to the firing channel housing by means of a screw connection. Since the gas generator is disposed in a fixed position relative to the firing channel housing, the gas generator can be disposed in such a manner that the expansion of the gas stored in the gas generator is directed onto the cover of the firing channel housing. As a result, during inflation the airbag is inflated principally in the direction of the passenger (i.e., the inflating movement of the airbag is substantially directed towards the cover of the firing channel housing).

The embodiments of the invention further relate to a motor vehicle dashboard which comprises a dashboard panel and an airbag arrangement which is developed and further developed as hereinbefore. The cover of the firing channel housing is hereby integrated substantially in a stepless manner into the dashboard panel so that additional components which need to be overcome when inflating the airbag are avoided without adversely affecting the design of the dashboard panel. In particular, the firing channel housing is formed by the dashboard panels. That is, the dashboard panel, the cover and the firing channel housing are a one-piece component manufactured in particular by pressure die casting. Additional casting means such as, for example, screw connections are thereby avoided so that the weight of the screws otherwise required is saved.

### BRIEF DESCRIPTION OF THE DRAWINGS

The present invention will hereinafter be described in conjunction with the following drawing figures, wherein like numerals denote like elements, and:

FIG. 1 shows a schematic sectional view of a first exemplary embodiment of an airbag arrangement according to the invention; and

FIG. 2 shows a schematic sectional view of a second exemplary embodiment of an airbag arrangement according to the invention.

### DETAILED DESCRIPTION

The following detailed description is merely exemplary in nature and is not intended to limit application and uses. Furthermore, there is no intention to be bound by any theory presented in the preceding background and summary or the following detailed description.

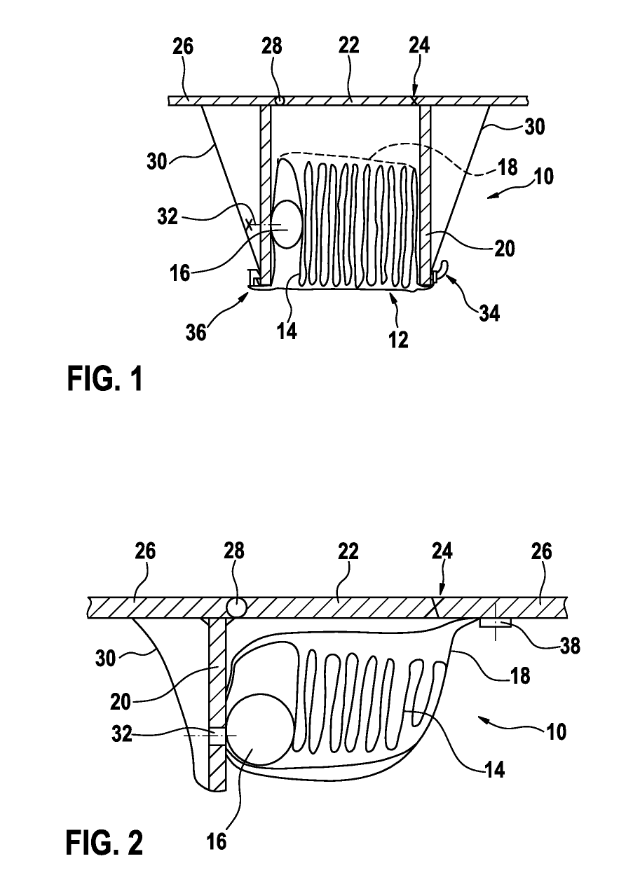

An airbag arrangement 10 according to the invention (FIG. 1) comprises an airbag module 12 with an airbag 14 and a gas generator 16. The airbag 14 and the gas generator 16 can be disposed inside a protective sleeve 18. The airbag module 12 is disposed inside a firing channel housing 20. The firing channel housing 20 is connected on the passenger side to a cover 22 which is connected to the firing channel housing 20 by means of a predetermined rupture line 24. In the exemplary embodiment shown, the cover 22 is integrated in a dashboard panel 26 of a motor vehicle dashboard and has a hinge 28 so that the cover cannot injure any motor vehicle occupants on opening. The firing channel housing 22 is connected by ribs 30 both to the firing channel housing 20 and also to the dashboard panel 26 with the result that the firing channel housing 20 is additionally stabilized. The gas generator 16 is firmly connected to the firing channel housing 20 by means of a screw connection 32, and the screw connection for fastening the gas generator 16 runs through the airbag 14 and the optionally provided protective sleeve 18. The gas generator 16 is connected so firmly to the firing channel housing 20 that escape of air in the area of the screw connection is avoided.

In the exemplary embodiment shown the airbag 14 is connected to the firing channel housing 20 on the right-hand side by means of a hook/eye connection 34. On the opposite side the airbag 14 is connected with the aid of a clip connection 32. Additionally or alternatively, the airbag module 12 can also be fastened with the aid of a tensioning strap whereby the airbag 14 and/or the protective sleeve 18 are clamped on the outer circumference of the firing channel housing 20 by means of the tensioning strap. Additionally or alternatively, the airbag module 12 can be locked to the firing channel housing 20, for example, with locking devices. Ferromagnetic regions can also be provided inside the airbag 14 in order to fasten the airbag module 12 magnetically with the aid of permanent magnets and/or electromagnets supplied from a car battery. A fastening frame, which is in particular sewn in, can be provided in the airbag module 12 in particular between the airbag 14 and the protective sleeve 18. With the aid of the fastening frame, the airbag module 12 can be screwed, for example, to the firing channel housing 20 without adversely affecting the airbag 14. The protective sleeve 18 can be made of the same material as the airbag 14. However, the protective sleeve 18 can also be made of a nonwoven or a netting. It is furthermore possible to manufacture the protective sleeve 18 from an in particular tear-resistant film which is in particular pre-stretched or stretched. Furthermore, the protective sleeve 18 can also be provided only at the lower end of the firing channel housing 20 in order to close the firing channel housing 20 at the bottom and prevent unintentional unfolding of the airbag 14 inside the firing channel housing 20.

In a further embodiment of the airbag arrangement according to the invention (FIG. 2), the firing channel housing 20 is reduced to a narrow wall section with the result that the weight is additionally reduced. In the exemplary embodiment shown the firing channel is completed by the protective sleeve 18. In this case, it is sufficient if the protective sleeve 18 is connected to the dashboard 26 at a first point by means of a connection 38, for example, by ultrasound welding and is connected to the firing channel housing 20 at a second point via the screw connection 32 of the gas generator 16. The airbag 14 is held in the desired shape at the predetermined position by the protective sleeve 18. A predetermined rupture region not shown ensures that on inflating, the airbag 14 can unfold through the protective sleeve 18 onto the cover 22. Since, compared to the embodiment of the airbag arrangement shown in FIG. 1, in the embodiment shown in FIG. 2 a part of the firing channel housing 20 is replaced by the protective sleeve 18, the embodiment shown in FIG. 2 is lighter.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. An airbag arrangement for a motor vehicle, comprising:
an airbag module comprising an airbag and a gas generator adapted to inflate the airbag;
a firing channel housing having the airbag module at least partially located inside the firing channel housing for target-oriented unfolding of the airbag;
a cover on the passenger side at least partially enclosing the firing channel housing, the cover having a predetermined rupture line,
wherein at least one of the airbag or a flexible protective sleeve at least partially surround the airbag and contacts the firing channel housing and is connected to the firing channel housing.

2. The airbag arrangement according to claim 1, wherein a tearing strength of the airbag connected to at least one of the firing channel housing or the protective sleeve connected to the firing channel housing is higher than a breaking strength of the predetermined rupture line.

3. The airbag arrangement according to claim 1, wherein the airbag connected to at least one of the firing channel housing or the protective sleeve connected to the firing channel housing completely closes the firing channel housing.

4. The airbag arrangement according to claim 1, wherein the protective sleeve partially forms a firing channel an other part of which is formed by the firing channel housing so that a closed firing channel is formed.

5. The airbag arrangement according to claim 1, wherein at least one of the airbag or the protective sleeve is connected to the firing channel housing with a detachable connection.

6. The airbag arrangement according to claim 1, wherein the at least one of airbag or the protective sleeve is connected to the firing channel housing with a hook-eye connection.

7. The airbag arrangement according to claim 1, wherein the firing channel housing is reinforced with a rib.

8. The airbag arrangement according to claim 1, wherein the firing channel housing is configured to be substantially tubular.

9. The airbag arrangement according to claim 1, wherein the gas generator is connected to the firing channel housing.

10. A motor vehicle dashboard, comprising:
a dashboard panel; and
an airbag arrangement, comprising:
an airbag module comprising an airbag and a gas generator adapted to inflate the airbag;
a firing channel housing having the airbag module at least partially located inside the firing channel housing for target-oriented unfolding of the airbag;
a cover on the passenger side at least partially enclosing the firing channel housing, the cover having a predetermined rupture line,
wherein at least one of the airbag or a flexible protective sleeve at least partially surround the airbag and contacts the firing channel housing and is connected to the firing channel housing

11. The airbag arrangement according to claim 1, wherein the at least one of airbag or the protective sleeve is connected to the firing channel housing with a locking connection.

12. The motor vehicle dashboard arrangement according to claim 10, wherein a tearing strength of the airbag connected to at least one of the firing channel housing or the protective sleeve connected to the firing channel housing is higher than a breaking strength of the predetermined rupture line.

13. The motor vehicle dashboard arrangement according to claim 10, wherein the airbag connected to at least one of the firing channel housing or the protective sleeve connected to the firing channel housing completely closes the firing channel housing.

14. The motor vehicle dashboard arrangement according to claim 10, wherein the protective sleeve partially forms a firing channel an other part of which is formed by the firing channel housing so that a closed firing channel is formed.

15. The motor vehicle dashboard arrangement according to claim 10, wherein at least one of the airbag or the protective sleeve is connected to the firing channel housing with a detachable connection.

16. The motor vehicle dashboard arrangement according to claim 10, wherein the at least one of airbag or the protective sleeve is connected to the firing channel housing with a hook-eye connection.

17. The motor vehicle dashboard arrangement according to claim 10, wherein the firing channel housing is reinforced with a rib.

18. The motor vehicle dashboard arrangement according to claim 10, wherein the firing channel housing is configured to be substantially tubular.
